(19) United States
(12) Patent Application Publication
(10) Pub. No.: US 2003/0137830 A1
(43) Pub. Date: Jul. 24, 2003

(54) Bulb positioning device for christmas lights

(76) Inventor: Shih-Chang Chang, Taichung (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/052,382

(22) Filed: Jan. 23, 2002

(51) Int. Cl. F21S 6/00

(52) U.S. Cl. 362/121; 362/122; 362/123; 362/326; 362/226

(57) ABSTRACT

A light device includes a ring-shaped positioning device having a plurality of flexible plates extending from a top end thereof at an angle so as to form an opening that is smaller than a central hole of the ring-shaped body. A decoration cover includes an engaging neck into which the ring-shaped body is engaged. A bulb assembly is inserted in the positioning device and a bulb of the bulb assembly is engaged with the opening and held by the flexible plates.

### FIELD OF THE INVENTION

The present invention relates to a bulb positioning device for Christmas lights wherein the frame for engaging with the bulb has plurality of plates and the bulb is held by the plates.

### BACKGROUND OF THE INVENTION

A conventional Christmas light generally includes a series of frames each with a bulb engaged therewith. The bulbs have different colors and most of which are made to be a one-piece with the frame. In other words, if the bulb is burned, the users cannot replace a new one. Some replaceable bulbs are developed and a decoration cover is mounted to the bulb so that the Christmas light may have various of shapes of decorations. The decoration covers each have their own opening for being engaged with a predetermined size of bulb. This limits the use of the bulbs and is not satisfied by the users.

### SUMMARY OF THE INVENTION

In accordance with one aspect of the present invention, there is provided a light device which comprises a positioning device that is a ring with a plurality of flexible plates extending at an angle from a top end thereof. An opening is defined and enclosed by the flexible plates and smaller than a central hole of the ring. A decoration cover includes an engaging neck in which the ring is inserted. A bulb assembly is inserted in the positioning device and a bulb of the bulb assembly is engaged with the opening in the positioning device and held by the flexible plates.

The primary object of the present invention is to provide a bulb positioning device which is connected to a decoration cover and has flexible plates so as to hold the bulb in different sizes.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the bulb positioning device, the decoration cover and the bulb assembly of the present invention;

FIG. 2 is a cross sectional view to show the engagement of the assembly as shown in FIG. 1;

FIG. 3 is an exploded view to show the bulb positioning device, another type of decoration cover and the bulb assembly of the present invention;

FIG. 4 is a cross sectional view to show the engagement of the assembly as shown in FIG. 3;

FIG. 5 is an exploded view to show the bulb positioning device, yet another type of decoration cover and the bulb assembly of the present invention, and

FIG. 6 is a cross sectional view to show the engagement of the assembly as shown in FIG. 5, and

FIG. 7 shows a Christmas tree decorated with the light devices of the present invention.

### DETAILED DESCRIPTION OF THE PREFERRED EMBODIMENTS

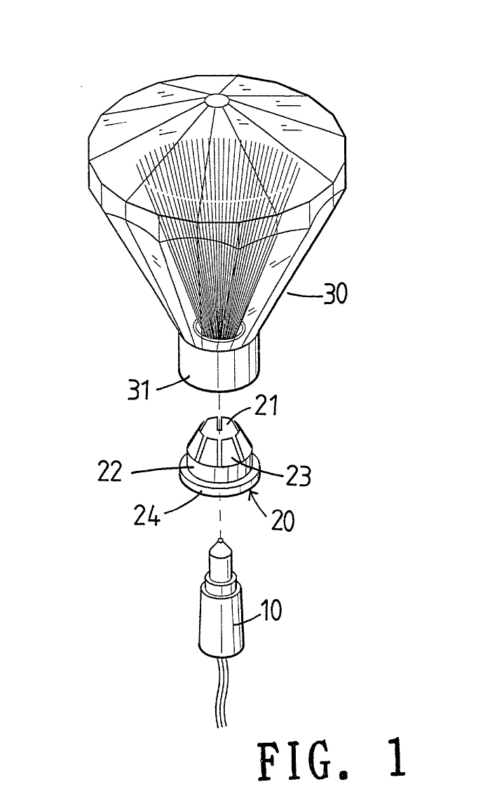

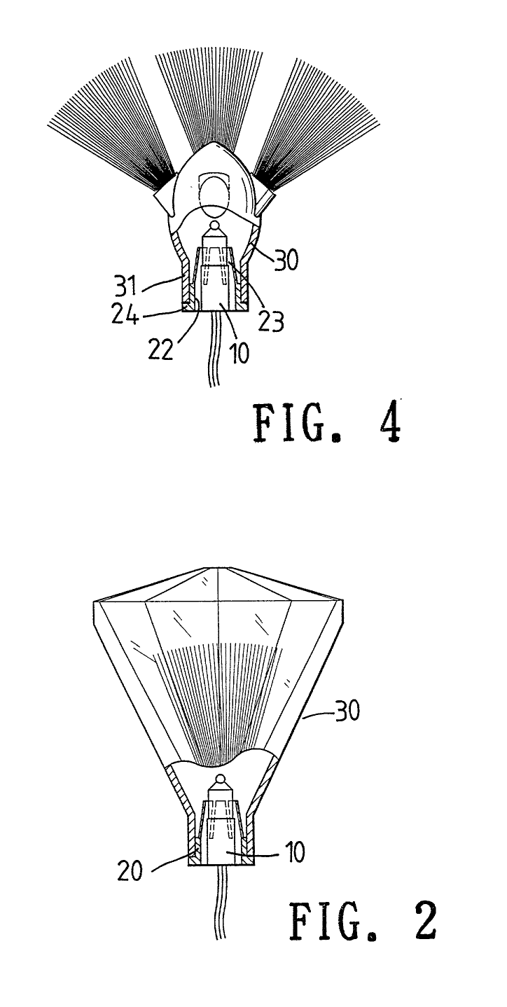

Referring to FIGS. 1 and 2, the Christmas light device of the present invention comprises a positioning device 20 which is a ring 22 with a plurality of flexible plates 23 extend at an angle from a top end of the ring 22. An opening 21 is enclosed by the flexible plates 23 and is smaller than a central hole of the ring 22. A flange 24 extends from a lower end of the ring 22.

A decoration cover 30 includes an engaging neck 31 and an closed cover with different shapes is connected to the engaging neck 31. The ring 22 is inserted in the engaging neck 31 and the flange 24 contacts against a lower opening end of the engaging neck 31.

A bulb assembly 10 is inserted in the positioning device 20 and a bulb of the bulb assembly 10 is engaged with the opening 21 in the positioning device 20 and held by the flexible plates 23.

When replacing the bulb assembly 10 which is simply removed from the ring 22 and then putting a new one in the ring 22. It is to be noted that the flexible plates 23 allow that different sizes of bulbs can be held by the flexible plates 23.

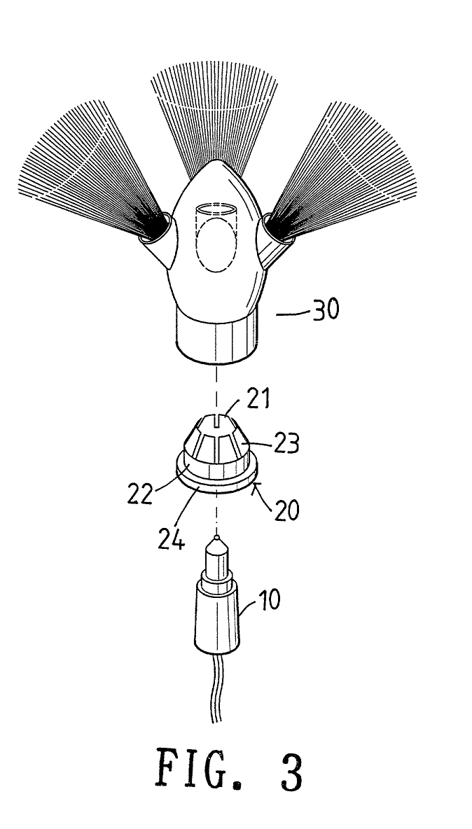

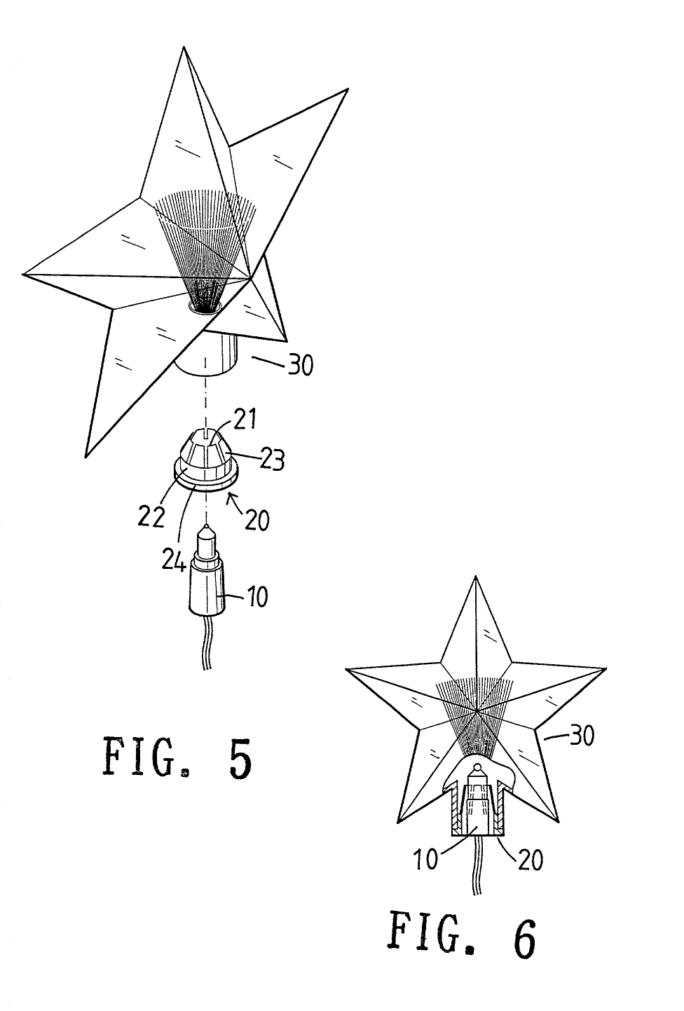

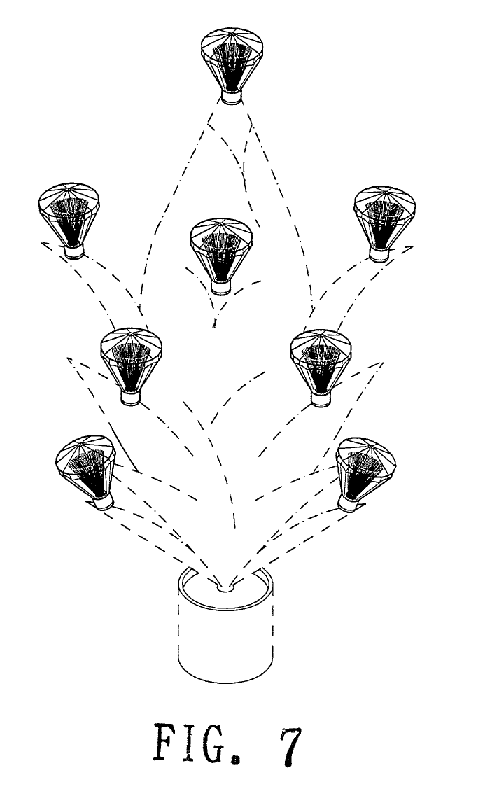

The closed cover of the decoration cover 30 may have different sizes and shapes such as the decoration cover 30 shown in FIGS. 3 to 6. FIG. 7 shows a Christmas tree decorated with the light devices of the present invention.

While we have shown and described the embodiment in accordance with the present invention, it should be clear to those skilled in the art that further embodiments may be made without departing from the scope of the present invention.

What is claimed is:

1. A light device comprising:
a positioning device being a ring and a plurality of flexible plates extending from a top end of the ring at an angle and a flange extending from a lower end of the ring, an opening defined and enclosed by the flexible plates and being smaller than a central hole of the ring;
a decoration cover including an engaging neck and the ring being inserted in the engaging neck, the flange contacting against a lower opening end of the engaging neck, and
a bulb assembly inserted in the ring and a bulb of the bulb assembly engaged with the opening enclosed by the flexible plates and being held by the flexible plates.
